(19) United States
(12) Patent Application Publication
(10) Pub. No.: US 2023/0342695 A1
(43) Pub. Date: Oct. 26, 2023

(54) System and Method for Graphical Matching of Complementary Businesses and Subsidiary Markets

(71) Applicant: Nima Veiseh, Grand Haven, MI (US)

(72) Inventor: Nima Veiseh, Grand Haven, MI (US)

(21) Appl. No.: 18/302,481

(22) Filed: Apr. 18, 2023

Related U.S. Application Data
(60) Provisional application No. 63/333,961, filed on Apr. 22, 2022.

(51) Int. Cl. G06Q 10/0637; G06Q 30/018; G06Q 30/0201

(52) U.S. Cl. CPC G06Q 10/0637; G06Q 30/018; G06Q 30/0201

(57) ABSTRACT

Disclosed is a system and method for graphical matching of complementary businesses and subsidiary markets.

The current application claims a priority to the U.S. provisional patent application Ser. No. 63/333,961 filed on Apr. 22, 2022.

### FIELD OF THE INVENTION

The present invention relates generally to a method. More specifically, the present invention is a method of reconciling contextually disconnected, yet economically beneficial, business partnerships.

### BACKGROUND OF THE INVENTION

In a world that is now interconnected in multiple ways, where business not only have their primary (a typical connection between a business that follows traditional funnel pipelines) business deal connections but also alternatively now have interest from “non-typical” outlets, that may emerge from within or outside of their ecosystem. For example, a farmer selling to a processing plant as the primary or traditional next step in the pipeline can now sell directly to a holistic care unit where they use fresh herbs in their remedies. The present invention provides a method of reconciling contextually disconnected, yet economically beneficial, business partnerships.

### BRIEF DESCRIPTION OF THE DRAWINGS

FIG. 1 is a diagram of the present invention.

FIG. 2 is another diagram of the present invention.

### DETAIL DESCRIPTIONS OF THE INVENTION

All illustrations of the drawings are for the purpose of describing selected versions of the present invention and are not intended to limit the scope of the present invention.

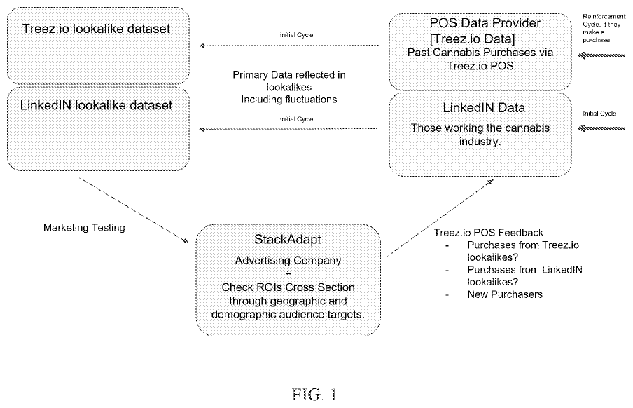

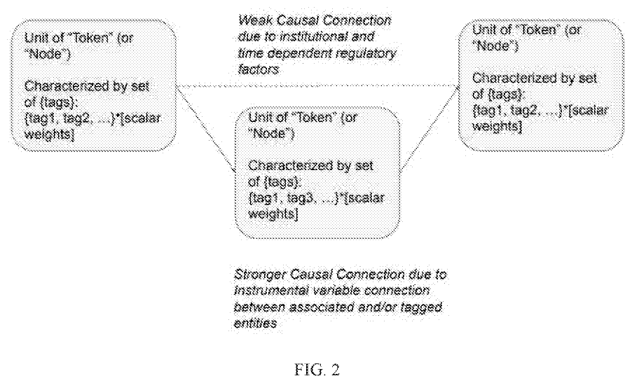

As can be seen in FIGS. 1 and 2, the present invention is an idea that a nonlinear rank and matching algorithm across a virtual graph DB that solves the problem of the four-dimensional analysis on engaging individuals to reconcile them for the mutual benefit of the creating marketplace transaction and what raining algorithm m does accounts for dynamic windows of communication that can be leveraged by am members with a sales team that may be independent in their approaches to the application but may find through a game-theoretic mated equilibrium they can utilize a previous activation to leverage that toward the closing of business transaction.

The complementary tables this solves the problem of NLP has their limitations what is need are complementary tables. Two types of limitations when trying a direct approach 1. Most people don't want—what is sold does not necessarily map in a 1.1 way to who wants to buy it\. A CBD manufacturer may want to sell to a disperse and a pharmacy. A complementary table needs to have a clear mapping table—A CBD product to the 2. There is a difference between companies that are direct inference that are being solved is that there is a difference between companies that have declared themselves as a part of a business market space and that that have not made such an outward declaration because which means that in order to capture the full universe of candidates entities of the marketplace there needs to be consideration for companies that are not only declaratively apart of that market such as a dispensary to cannabis to providers but also pharmacies that provide medicines that can be derived from the cannabis industry that should be included. There is an IV (Instrumental variable) that must linkage in an edge to a graph DB structure. Each node is a token and has the characteristics of “tags”.

The prior art for the present invention includes the following:
1. U.S. Pat. No. 8,639,616B1
2. U.S. Pat. No. 8,631,126B2
3. WO2006091528A3
4. WO2009110991A2
5. US20220013202A1
6. “Markets With Memory”, by Nima Veiseh, 2019.ISBN: 9781700165121
7. U.S. Pat. No. 8,112,625B2
8. U.S. Ser. No. 11/055,391B2
9. US20170091320A1
10. U.S. Pat. No. 8,943,076B2

Although the invention has been explained in relation to its preferred embodiment, it is to be understood that many other possible modifications and variations can be made without departing from the spirit and scope of the invention.

What is claimed is:

1. A method for graphical matching of complementary businesses and subsidiary markets, the method comprising the step of:
maintaining integrity, security, and anonymity of agents, participants, and nodes, which may be critical for the execution of the system, given an irregular or adverse regulatory environment.
